(19) United States
(12) Patent Application Publication
(10) Pub. No.: US 2024/0241741 A1
(43) Pub. Date: Jul. 18, 2024

(54) ASYNCHRONOUS, EFFICIENT, ACTIVE AND PASSIVE CONNECTION HEALTH MONITORING

(71) Applicant: VMware, Inc., Palo Alto, CA (US)

(72) Inventors: Petko PADEVSKI, Sofia (BG); Georgi LEKOV, Sofia (BG); Stanimir LUKANOV, Sofia (BG)

(73) Assignee: VMware, Inc., Palo Alto, CA (US)

(21) Appl. No.: 18/097,921

(22) Filed: Jan. 17, 2023

(51) Int. Cl. G06F 9/455

(52) U.S. Cl. CPC G06F 9/45558; G06F 2009/45583; G06F 2009/45591; G06F 2009/45595

(57) ABSTRACT

The disclosure provides an example method for connection health monitoring and troubleshooting. The method generally includes monitoring a plurality of connections established between a first application running on a first host and a second application running on a second host; based on the monitoring, detecting two or more connections of the plurality of connections have failed within a first time period; in response to detecting the two or more connections have failed within the first time period, determining to initiate a single health check between the first host and the second host and enqueuing a single health check request in a queue to invoke performance of the single health check based on the single health check request; determining the queue comprises: a queued active health check request, or no previously-queued health check requests; enqueuing the single health check request in the queue; and performing the single health check.

### BACKGROUND

Software defined networking (SDN) involves a plurality of hosts in communication over a physical network infrastructure of a data center (e.g., an on-premise data center or a cloud data center). The physical network to which the plurality of physical hosts are connected may be referred to as an underlay network. Each host has one or more virtualized endpoints such as virtual machines (VMs), containers, Docker containers, data compute nodes, isolated user space instances, namespace containers, and/or other virtual computing instances (VCIs) configured to run one or more applications. An application may be any software program, such as a word processing program. The VMs, running applications, on the hosts for example, may communicate with each other using an overlay network established by hosts using a tunneling protocol. Though certain aspects are discussed herein with respect to VMs, it should be noted that the techniques may apply to other suitable VCIs as well.

Each networked endpoint may use protocols based on an Open Systems Interconnection (OSI) model to allow for communication between applications running thereon. A networked endpoint may refer to a physical machine such as a host or a virtualized endpoint such as a VCI. The OSI model is an internationally accepted framework of communication standards. The OSI model creates an open intersystem networking environment where computing devices from any vendor connected to any network freely share data with other networked devices on the connected network. For example, each networked endpoint may provide a set of communication layers to allow for communication between each communicating application in the networked environment. The communication layers, from the bottom up, include a physical layer, a data link layer, a network layer, a transport layer, a session layer, a presentation layer, and an application layer, which are alternatively designated as Layers 1-7, respectively. Each layer of the OSI model handles a different role than the other layers, and one layer can only directly connect with the layers below and above itself. Due to these distinct characteristics between different layers, the OSI model has proven to be useful for narrowing down and pinpointing network issues to isolate the cause of a problem, where an issue in the communication exists.

In particular, multiple connections between applications in the networked environment may exist, where such connections are created using one or more protocols such as transmission control protocol (TCP), transport layer security (TLS), and/or the like. In order to form each of these connections between applications, network connections may also be established between VMs running these applications, as well as between hosts where the VMs are deployed. The connections between applications in the networked environment may experience issues on one or more layers of the network stack. For example, the issues may be due to general TCP connectivity errors, TLS handshake errors, hypertext transfer protocol (HTTP) errors, and/or application errors, to name a few. Thus, it is important for the distributed system of interconnected network devices to monitor the state connections in the system such that when an issue arises, the system may act accordingly depending on the source of the issue (e.g., the layer in the network stack where the issue is present). Such proactive monitoring and mitigation efforts may allow the system to continuously function with minimal interruptions and high availability.

An example network performance monitoring and troubleshooting process may involve performing health checks between connections in the system where issues are detected between these connections, based on the monitoring. A health check may include checking each layer of the network stack to identify a root cause of the issue. For example, the health check may include attempting to open a TCP connection to a networked endpoint on a specified port. Failure to connect within a configured timeout may be considered unhealthy. Resources may be allocated to allow for performance of each of these health checks. Resources may refer to the processor resources, memory resources, networking resources, operating system (OS) resources (e.g., threads, file descriptors, etc.) and/or the like provided by a computing device where the health check is being performed.

In distributed systems where multiple connections may exist, hardware resources are likely to become quickly exhausted, and in some cases wasted, when an issue occurs. For example, a multitude of connections may be established between applications running on a first networked endpoint and applications running on a second networked endpoint. As an illustrative example, thirty connections may be established between each of a first application on the first endpoint and a first application on the second endpoint, the first application on the first endpoint and a second application on the second endpoint, the first application on the first endpoint and a third application on the second endpoint, etc. Additionally, a similar number of connections may be made for a second application, a third application, etc. running on the first endpoint. In a case where a TCP connectivity issue arises due to an error at the transport layer of the second endpoint, all connections between applications running on the first endpoint and applications running on the second endpoint may be affected. As such, resources of the first endpoint may be allocated for each connection between the first and second endpoints such that a health check is performed for each connection affected by the transport layer error. The health check performed for each connection may fail and attribute the failure to the error at the transport layer of the second endpoint. Thus, in this case, resources at the first endpoint may be unnecessarily wasted to report a same failure for each of the multitude of connections.

This problem is further exacerbated by the fact that connections in the system can also be established indirectly. For example, endpoints in the system may be configured to forward user connection footprint to other portions of the distributed system thereby creating additional connections within the system. Thus, the number of connections that may be affected by a single issue in the network stack at a particular endpoint in the system may be exponential. These additional connections may result in even more health checks needing to be performed in the system for a single network layer issue.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for connection health monitoring and troubleshooting. The method generally includes monitoring a plurality of connections established between a first application running on a first host and a second application running on a second host; based on the monitoring, detecting two or more connections of the plurality of connections have failed within a first time period; in response to detecting the two or more connections have failed within the first time period, determining to initiate a single health check between the first host and the second host as opposed to a separate health check between the first host and the second host for each of the two or more connections, wherein initiating the single health check comprises enqueuing a single health check request in a queue to invoke performance of the single health check based on the single health check request; determining the queue comprises: a queued active health check request, or no previously-queued health check requests; enqueuing the single health check request in the queue; and performing the single health check based on the single health check request and an order of the single health check request within the queue.

Further embodiments include a non-transitory computer-readable storage medium storing instructions that, when executed by a computer system, causes the computer system to perform the method set forth above, and a computer system including at least one processor and memory configured to carry out the method set forth above.

### BRIEF DESCRIPTION OF THE DRAWINGS

FIG. 1 illustrates a computing system in which embodiments described herein may be implemented.

FIGS. 2A-2C illustrate example operations for health checking application layer connections, according to one or more embodiments of the present disclosure.

FIG. 3 illustrates example operations for providing health check results to a callback requesting application, according to one or more embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Improved techniques for connection health monitoring and troubleshooting in distributed systems are described herein. For example, embodiments herein introduce health monitor(s) and health checker(s) to engage in network performance monitoring and diagnosis, where necessary, with reduced resource utilization.

One or more health monitors and one or more health checkers may be running in one or more virtual machines (VMs) in the distributed system. Though certain aspects are described with respect to health monitors and health checkers running on VMs to check connections between VMs (e.g., applications running on VMs), it should be noted that the techniques herein similarly apply to health monitors and health checkers running on any network entities (e.g., virtualized endpoints, physical computing device, etc.) to check connections between any network entities (e.g., applications running on network entities).

A health monitor is configured to monitor the health of connections made by at least one application with other applications in the distributed system. The other applications may be running in different VMs on a same host as the application initiating the connection or running in VMs on other hosts in the system. There may be a single health monitor deployed for each VM having applications running therein and/or a single health monitor deployed for each application (e.g., two health monitors deployed for two applications running in a single VM and using different application layer protocols). Further, the health monitor is configured to trigger a health check for one or more connections in the system that the health monitor determines to have failed. In certain embodiments, the health monitor is configured to deduplicate health checks (e.g., eliminate redundant or duplicated health checks) initiated for multiple failed connections within a time frame, such that only a single health check is triggered for each of these connections. For example, where thirty connections are established between a first application running in a first VM (e.g., on a first host) and a second application running in a second VM (e.g., on a second host) and five of the thirty connections fail within a specified time period (e.g., five seconds), a health monitor detecting such failures may deduplicate the five health checks which are to be performed for each of these five connections (e.g., one triggered per failed connection) to a single health check.

To initiate a health check, the health monitor is configured to enqueue in a serial work queue an invocation to a health checker deployed on a same computing machine (e.g., a same VM) as the health monitor. The serial work queue is configured to store health check requests in an order of insertion such that each inserted health check request is processed in the order it is received (e.g., serially). Further, the serial work queue is configured to allow only two enqueued health check requests at a single time: (1) one scheduled/pending health check and (2) one active health check (e.g., currently in progress). Allowing a second queued work item (e.g., the schedule/pending health check) in the serial work queue may be useful in cases where an error at a particular layer in the network stack occurs subsequent to beginning performance of the active health check (e.g., after determining that no issues exist at this layer in the active health check). Further, the combination of deduplication efforts to reduce redundant health checks within a same time period and configuration of the serial work queue to only allow two enqueued health check requests at a point in time, helps to reduce resource utilization at a host where the health monitor and health checker are running. Improving resource utilization at multiple hosts within the distributed system, while continuing to allow for connection health monitoring and troubleshooting at each of these hosts, may help to enhance system scalability and availability.

The health checker is configured to initialize resources necessary for performing each health check requested by a health monitor deployed on a same computing machine as the health checker. Further, the health checker is configured to perform each enqueued health check. Performing the health check includes checking whether one or more issues exist at different layers of a network stack implemented at a host where an application associated with the failed connection(s) (e.g., which initiate the health check) is deployed. Results of performing the health check may indicate whether the system is healthy, degraded, or unhealthy. Mitigating actions may be taken where the system is determined to be degraded or unhealthy.

In certain embodiments, the health monitor is configured to initiate subsequent health check(s) where the results of a previously performed health check indicate that the system is unhealthy or degraded. For example, the health monitor may schedule subsequent health checks for the system at a predetermined interval or an increasing interval (e.g., to save resources). The system is designed to be robust and thus recover, in some cases, without user interaction. Accordingly, these recurrent health checks may help to monitor the state of the system should it recover independently. These health checks may discontinue when the system is determined to be healthy again.

In certain embodiments, other components and/or other applications in the system may request a callback from a health monitor when a health check has completed. The callback requesting applications may be applications that do not have a failed connection and thus did not cause the initiation of a health check. When a health check is finished, each component and/or application which requested a callback may be informed of the status (e.g., healthy, degraded, or unhealthy) of the system. Such callback features allow for passive monitoring by the components and/or other applications in the system. In certain embodiments, such passive monitoring may allow for the display of an alarm notifying a user that specific operations are expected to fail while the connection is unhealthy. As such, the alarm may help to prevent further operations initiated by the user that may drain system resources.

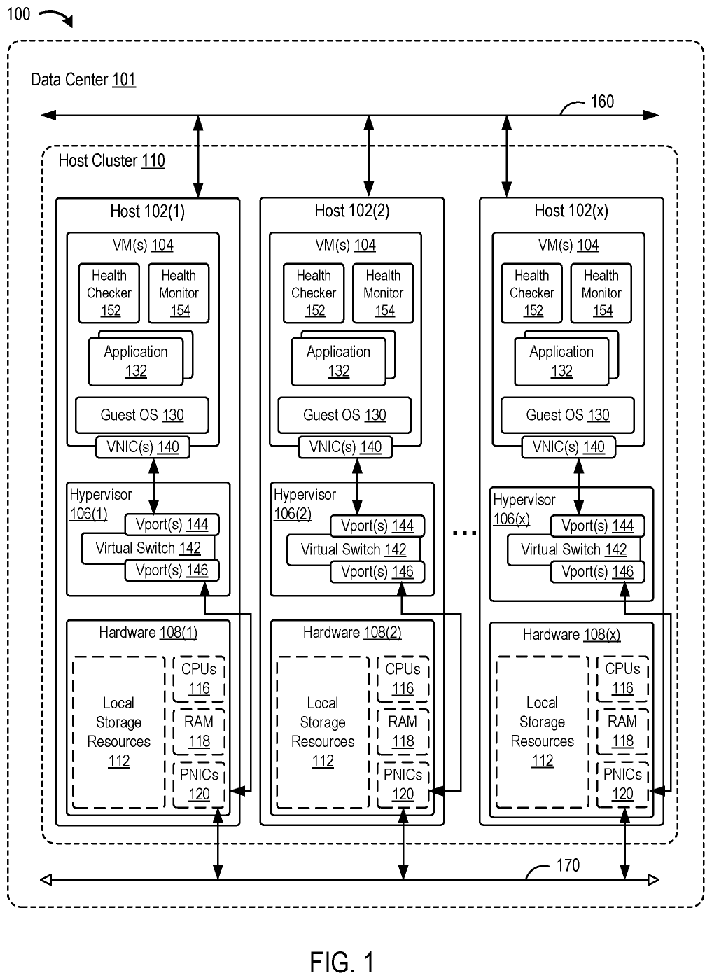

FIG. 1 depicts example physical and virtual network components in a networking environment 100 in which embodiments of the present disclosure may be implemented. Networking environment 100 includes a data center 101. Data center 101 includes one or more hosts 102, a management network 160, and a data network 170. Data network 170 and management network 160 may be implemented as separate physical networks or as separate virtual local area networks (VLANs) on the same physical network.

Host(s) 102 may be communicatively connected to data network 170 and management network 160. Data network 170 and management network 160 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 102 may be geographically co-located servers on the same rack or on different racks in any arbitrary location in data center 101. Host(s) 102 may be in a single host cluster 110 (as shown) or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 1041 to 104N (collectively referred to as VMs 104 and individually referred to as VM 104) that run concurrently on the same host 102.

Host(s) 102 may be constructed on a server grade hardware platform 108, such as an x86 architecture platform. Hardware platform 108 of each host 102 includes components of a computing device such as one or more processors (central processing units (CPUs)) 116, memory (random access memory (RAM)) 118, one or more network interfaces (e.g., physical network interface cards (PNICs) 120), storage 112, and other components (not shown). CPU 116 is configured to execute instructions that may be stored in memory 118 and/or in storage 112. The network interface(s) enable hosts 102 to communicate with other devices via a physical network, such as management network 160 and/or data network 170.

In certain embodiments, hypervisor 106 may run in conjunction with an operating system (not shown) in host 102. In some embodiments, hypervisor 106 can be installed as system level software directly on hardware platform 108 of host 102 (often referred to as “bare metal” installation) and be conceptually interposed between the physical hardware and guest operating systems 130 executing in the VMs 104. It is noted that the term “operating system,” as used herein, may refer to a hypervisor.

In certain embodiments, hypervisor 106 implements one or more logical switches as a virtual switch 142. Any arbitrary set of VMs in a datacenter may be placed in communication across a logical Layer 2 (L2) overlay network by connecting them to a logical switch. A logical switch is an abstraction of a physical switch that is collectively implemented by a set of virtual switches on each host 102 that has a VM 104 connected to the logical switch. The virtual switch 142 on each host 102 operates as a managed edge switch implemented in software by a hypervisor 106 on each host 102. Virtual switches 142 provide packet forwarding and networking capabilities to VMs 104 running on the host. In particular, each virtual switch uses hardware based switching techniques to connect and transmit data between VMs 104 on a same host 102, or different hosts 102

A virtual switch 142 may be a virtual switch attached to a default port group defined by a network manager that provides network connectivity to a host 102 and VMs 104 on the host 102. Port groups include subsets of virtual ports (“Vports”) of a virtual switch, each port group having a set of logical rules according to a policy configured for the port group. Each port group may comprise a set of Vports associated with one or more virtual switches on one or more hosts 102. Ports associated with a port group may be attached to a common VLAN according to the IEEE 802.1Q specification to isolate the broadcast domain.

A virtual switch 142 may be a virtual distributed switch (VDS). In this case, each host 102 may implement a separate virtual switch corresponding to the VDS, but the virtual switches 124 at each host 102 may be managed like a single virtual distributed switch (not shown) across the hosts 102.

Each of VMs 104 running on each host 102 may include virtual interfaces, often referred to as virtual network interface cards (VNICs), such as VNICs 140, which are responsible for exchanging packets between VMs 104 and hypervisor 106. VNICs 140 can connect to Vports 144, provided by virtual switch 142. In this context “connect to” refers to the capability of conveying network traffic, such as individual network packets, or packet descriptors, pointers, identifiers, etc., between components so as to effectuate a virtual datapath between software components. Virtual switch 142 also has Vport(s) 146 connected to PNIC(s) 120, such as to allow VMs 104 (and applications 132, health checker 152, and health monitor 154 running in VMs 104, as described below) to communicate with virtual or physical computing devices outside of host 102 via management network 160 and/or data network 170.

Each of VMs 104 implements a virtual hardware platform that supports the installation of a guest OS 130 which is capable of executing one or more applications 132. Guest OS 130 may be a standard, commodity operating system. Examples of a guest OS include Microsoft Windows, Linux, and/or the like. In certain embodiments, applications 132 running in VMs 104 in host cluster 110 make up distributed application(s). A distributed application is software that is executed or run on multiple hosts 102 (e.g., or VMs 104) within networked environment 100. These applications 132 running on different VMs 104 and/or hosts 102 interact in order to achieve a specific goal or task. Thus, connections may be made between each of the applications running within networked environment 100.

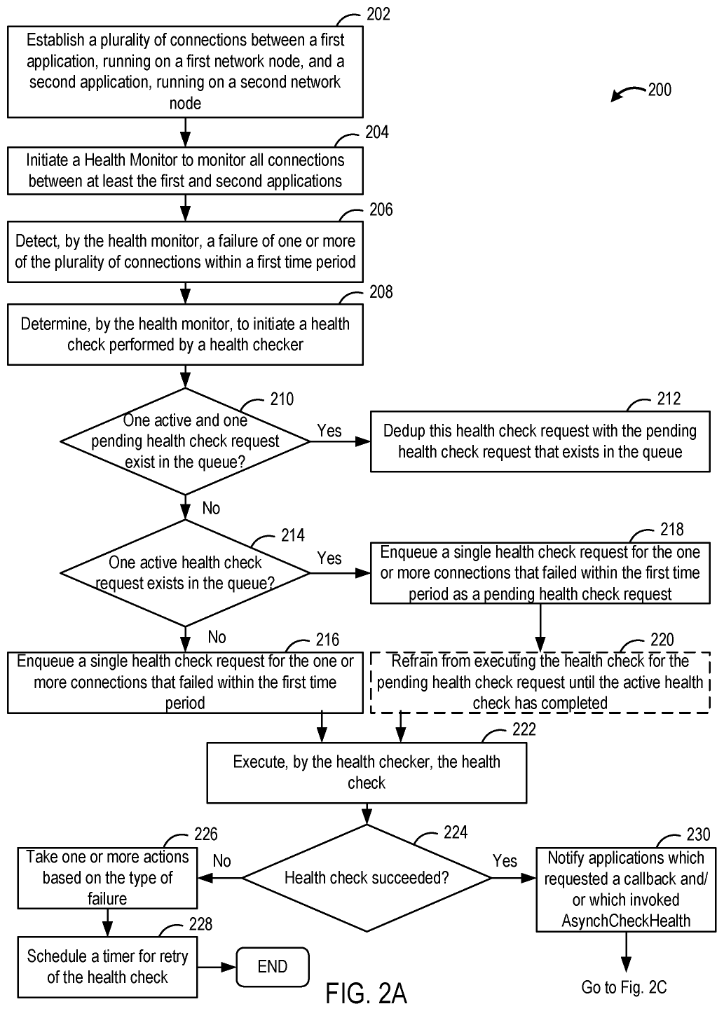

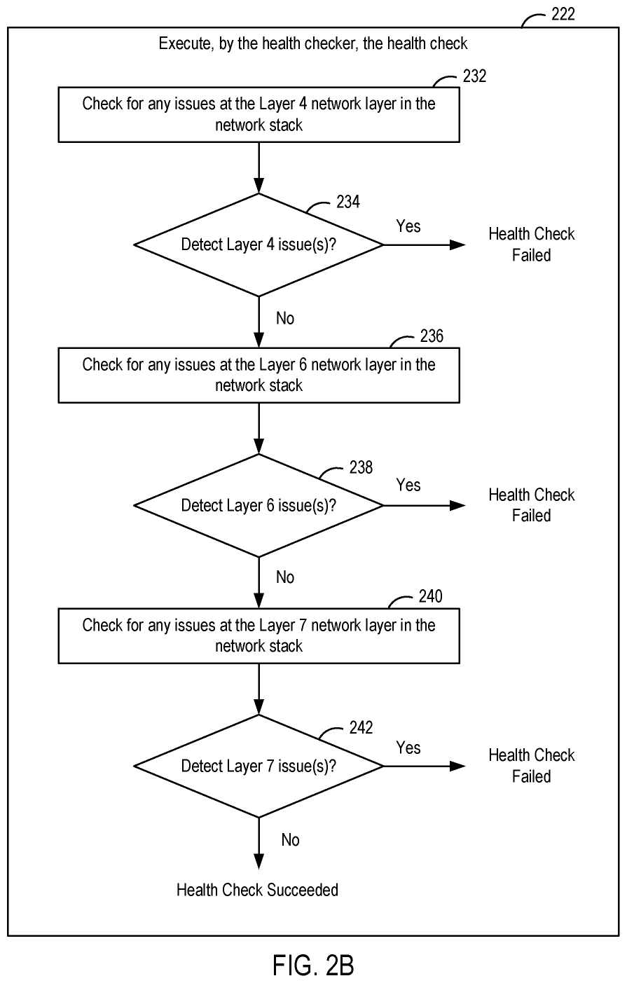

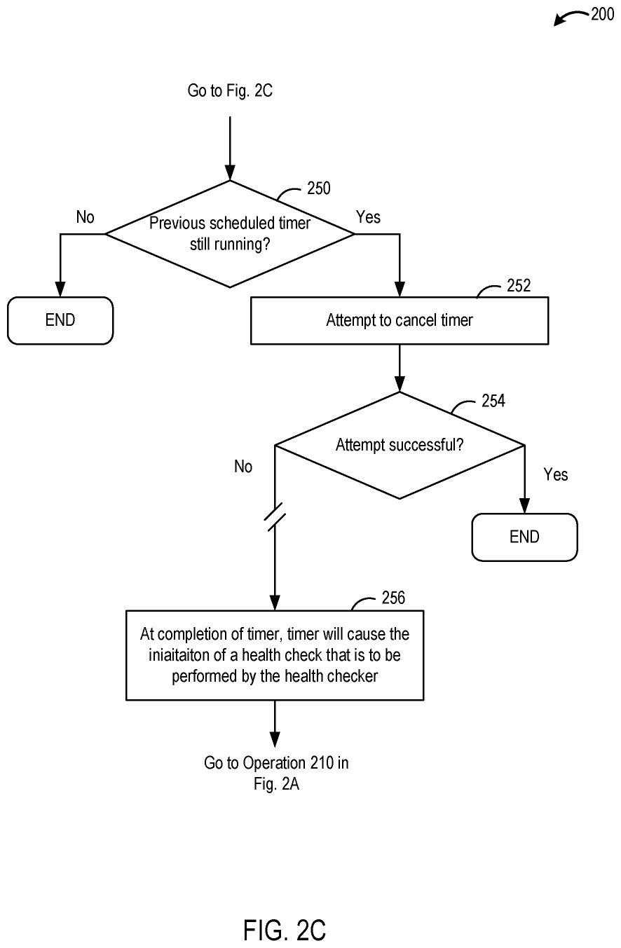

Further, each of VMs 104 implements a health monitor 154 and a health checker 152 for health monitoring and troubleshooting of connections between applications 132. For example, health monitor 154 and health checker 152 on host 102(1) may be configured to monitor for failed connections between, for example, application 132 running in VM 104 on host 102(1) and application 132 running in VM 104 on host 102(2). Further, where a connection is determined to fail (e.g., based on the monitoring), health monitor 154 and health checker 152 on host 102(1) may be configured to initiate and perform a health check, respectively, to understand whether the system is healthy, degraded, or unhealthy. Performing the health check includes checking whether one or more issues exist at different layers of a network stack implemented at a host 102 where health monitor 154 and health checker 152 are deployed. In certain embodiments, this includes checking whether issues exist at a transport layer (e.g., Layer 4), a presentation layer (e.g., Layer 6), and/or an application layer (e.g., Layer 7) of the network stack. Although embodiments herein are described with respect to checking whether an issue exists at Layer 4, Layer 6, and/or Layer 7 of the network stack, other embodiments may consider checking whether issues exist at one or more other layers of the network stack when performing the health check. Details regarding the initiation and performance of health checks for connections between applications 132 in networking environment 100 are described in detail with respect to FIGS. 2A-2C.

Although embodiments herein illustrate each VM 104 implementing a health monitor 154 and a health checker 152, in certain other embodiments, a health monitor 154 and a health checker 152 may be deployed for each application 132 (e.g., instead of for multiple applications 132 running in a single VM 104). In certain other embodiments, a single health monitor 154 and a single health checker 152 may be deployed in a single application running in a virtualization manager deployed for data center 101 to monitor and troubleshoot connections between the virtualization manager and each application 132 running in each VM 104 on each host 102 in data center 101. In certain embodiments, the application may be a virtual provisioning X daemon (vpxd) running in a virtualization manager deployed for host cluster 110. The virtualization manager (not shown in FIG. 1) may be a computer program that resides and executes in a central server in data center 101 or, alternatively, the virtualization manager may run as a virtual computing instance (e.g., a VM) in one of hosts 102. In certain embodiments, the virtualization manager communicates with hosts 102 via a network, shown as management network 160 in FIG. 1, and carries out administrative tasks for data center 101 such as managing hosts 102, managing VMs 104 running within each host 102, provisioning VMs 104, migrating VMs 104 from one host to another host, and load balancing between hosts 105.

FIGS. 2A-2C illustrate example operations 200 for health checking application layer connections, according to one or more embodiments of the present disclosure. Each health monitor 154 and health checker 152, such as deployed within each VM 104, as illustrated in FIG. 1, may be configured to perform operations 200 illustrated in FIGS. 2A-2C. For ease of explanation, operations 200 may be described with respect to health monitor 154 and health checker 152, in VM 104 on host 102(1), initiating and performing a health check for failed connections between application 132 running in VM 104 on host 102(1) (e.g., a first application) and application 132 running in VM 104 on host 102(2) (e.g., a second application).

As illustrated, operations 200 begin at block 202, by establishing a plurality of connections between the first application, and the second application. Although not meant to be limiting to this particular example, it may be assumed that twenty-five connections are established between the first application and the second application. Further, it may be assumed, that five of twenty-five connections are established by a first user of the first application, five of the twenty-five connections are established by a second user of the first application, five of the twenty-five connections are established by a third user of the first application, five of the twenty-five connections are established by a fourth user of the first application, and five of the twenty-five connections are established by a fifth user of the first application (e.g., using credential specific to each of the five different users).

At block 204, operations 200 proceed with initiating a health monitor to monitor all connections between at least the first application and the second application. As described above, the health monitor may be health monitor 154 running in VM 104 on host 102(1). Health monitor 154 may have already been deployed and configured to monitor connections of other applications 132 running in VM 104. In cases where health monitor 154 was not previously deployed, initiating health monitor 154 at block 204 includes deploying health monitor 154 in VM 104 on host 102(1). In this example, health monitor 154 is configured to monitor at least the twenty-five connections between the first application and the second application.

At block 206, operations 200 proceed with detecting, by health monitor 154, a failure of one or more of the plurality of connections within a first time period. Although not meant to be limiting to this particular example, it may be assumed that health monitor 154 detects (based on the monitoring) that five of the twenty-five connections between the first application and the second application have failed within the first time period (e.g., five seconds). The five failed connections may include two connections established by the first user, two connections established by the second user, and one connection established by the third user.

At block 208, health monitor 154 determines to initiate a single health check that is to be performed by a health checker, such as health checker 152 running in VM 104 (e.g., the same VM 104 as health monitor 154) on host 102(1). Health monitor 154 determines to initiate the single health check in response to detecting the five failed connections. For this example, health monitor 154 may initiate a single health check for the five connections. In other words, health monitor 154 may determine that a health check is to be performed for each of the five failed connections and deduplicate the health check that is initiated for each of the five failed connections into a single health check, such that only one health check is performed (e.g., based on generating a single health check request for the five failed connections).

The health checks triggered for each failed connection may be deduplicated to a single health check (e.g., a single health check request) based on each of these failed connections happening within a same first time period. For example, because all five connections are determined to have failed within the five second time interval, health checks which are to be triggered for each of these five connections may be deduplicated to a single health check, such that only a sing health check request is generated by health monitor 154. In other cases where all failed connections do not occur within the first time period, multiple health check requests may be created. For example, where a total of ten connections fail, and eight of the failures are detected within a first time interval (e.g., between 0-5 seconds) and two of the failures are detected within a second time interval (e.g., between 5-10 seconds), two health check requests may be created. More specifically, health checks which are to be triggered for each of eight connections (e.g., of the first time interval) may be deduplicated to a first health check request and health checks which are to be triggered for each of two connections (e.g., of the second time interval) may be deduplicated to a second health check request.

At block 210, health monitor 154 determines whether one active health check request and one pending health check request currently exist in a serial work queue. As described above, the serial work queue is configured to allow only two enqueued health check requests at a single time.

Where at block 210, health monitor 154 determines that one active health check request and one pending health check request do exist in the queue (e.g., both are present in the queue), at block 212, health monitor 154 deduplicates the health check request (e.g., for the five failed connections) with the pending health check request that currently exists in the queue. For example, the pending health check request may be for two connections that health monitor 154 determined to have failed a period of time before the five connections failed. Thus, by deduplicating the health check request for the five failed connections with the pending health check request associated with the two previously failed connections, the pending health check request may now be enqueued for these seven connections. Deduplication of the health check is necessary in this case as the serial work queue is full (e.g., contains both an active and a pending health check request) when health monitor 154 determines that a health check is to be initiated for the five failed connections.

Alternatively, where at block 210, health monitor 154 determines that one active health check request and one pending health check request do not exist in the queue (e.g., both are not present in the queue), at block 214, health monitor 154 determines whether one active health check request exists in the queue (e.g., without a pending health check). Where at block 214, health monitor 154 determines that one active health check request does not exist in the queue, at operation 216, health monitor 154 enqueues the single health check request for the five connections which failed within the first time period. In other words, because the queue is empty (e.g., does not include an active health check request, nor a pending health check request), the health check request may be enqueued. Further, the health check request enqueued in the queue may become the active health check request in the queue.

On the other hand, where at block 214, health monitor 154 determines that one active health check request currently exists in the queue (e.g., without a pending health check request), at block 218, health monitor 154 enqueues the single health check request for the five connections which failed within the first time period. In other words, because the queue only contains an active health check request, and does not contain a pending health check request, the queue is not full and the health check request (e.g., for the five failed connections) may be enqueued. Further, the health check request enqueued in the queue may become the pending health check request in the queue.

At block 222, operations 200 proceed with executing a health check for the enqueued health check request associated with the five failed connections. The health check may be performed by health checker 152. Where the health check request was enqueued as the active health check request in the queue (e.g., at operation 216), the health check may be immediately performed by health checker 152. Alternatively, where the health check request was enqueued as the pending health check request in the queue (e.g., at block 218), at operation 220, health checker 152 may refrain from executing the health check for the pending health check request until health checker 152 has completed the health check for the active health check request in the queue.

Details regarding performance of the health check by health checker 152, at block 222, are described with respect to FIG. 2B. As illustrated in FIG. 2B, to perform the health check, health checker 152 checks whether issues exist at a transport layer (e.g., Layer 4), a presentation layer (e.g., Layer 6), and/or an application layer (e.g., Layer 7) of the network stack.

For example, to begin the health check at block 222, at block 232, health checker 152 checks for any issues at the Layer 4 network layer in the network stack implemented at host 102(1). Layer 4, also known as the transport layer, is configured to manage network traffic between hosts 102 and/or other components to help ensure complete data transfers. Transport-layer protocols such as transmission control protocol (TCP), user datagram protocol (UDP), datagram congestion control protocol (DCCP), and stream control transmission protocol (SCTP) are used to control the volume of data, where it is sent, and at what rate. In certain embodiments, to check for the existence of issues at the Layer 4 network layer, health checker 152 is configured to attempt to establish a TCP connection between the first application and the second application. A Layer 4 issue may exist where the attempted TCP connection is unsuccessful (e.g., fails) and/or is not successful within a configured timeout period.

In certain embodiments, to check for the existence of issues at the Layer 4 network layer, as a first step, a domain name system (DNS) lookup is performed to convert a domain name into an IP address. Where a DNS lookup is successful, an IP address may be returned. On the other hand, where the DNS lookup is not successful, an error string may be returned indicating an issue at the Layer 4 network layer exists. As a second step (e.g., where the IP address is returned), a connection using the returned IP address may be attempted. An unsuccessful attempt (e.g., indicating a Layer 4 issue exists) may occur where the destination application 132 (e.g., attempting to connect with) has crashed, a switch and/or router notices that the destination application 132 is unreachable, the destination application 132 fails to respond to the connection request, the network packet drop rate is high, and/or the like.

At block 234, health checker 152 determines whether one or more Layer 4 issues have been detected based on the check performed at block 232. Where at block 234, at least one Layer 4 issue is detected, health checker 152 determines that the health check has failed. Further, in certain embodiments, health checker 152 determines whether the system is degraded or unhealthy.

Alternatively, where at block 234, no Layer 4 issues are detected by health checker 152, at block 236, health checker 152 checks for any issues at the Layer 6 network layer in the network stack implemented at host 102(1). Layer 6, also known as the presentation layer, is responsible for the preparation and/or translation of data from an application format to a network format, and/or vice versa. In other words, Layer 6 “presents” data for an application or the network. For example, Layer 6 may be responsible for encryption and/or decryption of data for secure transmission. In certain embodiments, to check for the existence of issues at the Layer 6 network layer, health checker 152 is configured to attempt to establish a transport layer security (TLS) connection between the first application and the second application. A TLS connection is initiated using a sequence known as the TLS handshake. During a TLS handshake, the first application and the second application may exchange messages to acknowledge each other, verify each other, establish the cryptographic algorithms they will use, and/or agree on session keys. A TLS handshake error occurs when the first application and the second application are unable to establish a communication over the TLS protocol. In some cases, this may be due to an expired certificate at the second application. For example, certificates at the second application may be short-lived; thus, the certificate at the second application may be expired. Accordingly, the first application may not trust the expired certificate at the second application, and the TLS handshake attempt may fail. In some other cases, a TLS handshake error occurs where the certificate at the second application was previously renewed. For example, during the renewal process, a Fully Qualified Domain Name (FQDN)/DNS name and/or an IP address that was previously trusted by the first application is changed to a name and/or address that is no longer trusted by the first application. Accordingly, because the first application does not trust the renewed certificate at the second application, the TLS handshake attempt fails. A Layer 6 issue may exist where the attempted TLS connection is unsuccessful and/or is not successful within a configured timeout period.

At block 238, health checker 152 determines whether one or more Layer 6 issues have been detected based on the check performed at block 236. Where at block 238, at least one Layer 6 issue is detected, health checker 152 determines that the health check has failed. Further, in certain embodiments, health checker 152 determines whether the system is degraded or unhealthy.

Alternatively, where at block 238, no Layer 6 issues are detected by health checker 152, at block 240, health checker 152 checks for any issues at the Layer 7 network layer in the network stack implemented at host 102(1). Layer 7, also known as the application layer, is responsible for supporting end-user applications and processes. More specifically, Layer 7 is configured to identify users of different applications as they communicate, assess service quality, and deal with issues such as constraints on data syntax, user authentication, and/or privacy. In certain embodiments, to check for the existence of issues at the Layer 7 network layer, health checker 152 is configured to issue and validate security tokens. Security tokens may contain information about a user and a resource for which the token is intended. The information can be used to access protected resources. Security tokens are validated by resources to grant access to an application, for example, the second application. Thus, to validate a security token issued to a user, health checker 152 may determine whether the user is able to use their token when logging into the second application. A Layer 7 issue may exist where the attempted login is unsuccessful and/or is not successful within a configured timeout period.

In certain embodiments, a Layer 7 issue may also exist where an attempt to access an application is unsuccessful because (1) the initial request could not be desearialized due to a lack of required data within the request, (2) the application for which the request was directed could not be found, (3) an invalid username and/or password was provided, (4) a provided token (e.g., a Security Assertion Markup Language (SAML) Holder-of-Key (HoK)/Bearer Token or a JSON Web Token (JWT)) could not be verified and/or is not trusted, and/or the like,

At block 242, health checker 152 determines whether one or more Layer 7 issues have been detected based on the check performed at block 240. Where at block 240, at least one Layer 7 issue is detected, health checker 152 determines that the health check has failed. Further, in certain embodiments, health checker 152 determines whether the system is degraded or unhealthy.

Alternatively, where at block 238, no Layer 7 issues are detected by health checker 152, at block 240, health checker 152 determines that the health check has failed. In other words, health checker 152 determines that the system is healthy.

Returning to FIG. 2A, after performing operations at block 222, at block 224, health checker 152 determines whether the health check succeeded. Where at block 224 health checker 152 determines that the health check has failed (e.g., the system is determined to be degraded or unhealthy), at block 226, one or more actions may be taken based on the type of failure. In certain embodiments, the one or more actions are performed automatically by the system. In other words, the system may be designed to self-heal without user interaction. In certain embodiments, the one or more actions include informing a user (e.g., an administrator) about the current issue(s) (e.g., via a UI) to trigger further action by the user.

For example, where a Layer 4 issue is detected (e.g., at block 234 in FIG. 2B) due to an inability to establish a TCP connection with the second application, the one or more actions may include ceasing connections between the first application and second application. In particular, a TCP connection with the second application may not have been successful due to the second application indicating previously that the second application desired to terminate connections between the first application and the second application. The second application may have previously made this indication via the transmission of a TCP reset (RST) packet. An RST packet is used by an application to indicate that it will neither accept nor receive more data. An application may generate and inject RST packets in order to terminate undesired connections. In this case, it is possible that the first application did not previously, successfully receive these RST packet(s) which is why the TCP connection is now failing. As such, connections between the first and second applications may be stopped.

As another example, where a Layer 6 issue is detected (e.g., at block 238 in FIG. 2B) due to an inability to establish a TLS connection with the second application as a result of an expired certificate at the second application), the one or more actions may include updating a certificate at the second application. Alternatively, the one or more actions may include preventing connections with the second application, as the certificate on the second application has become untrustworthy to the first application.

As another example, where a Layer 7 issue is detected (e.g., at block 238 in FIG. 2B) due to an inability use security tokens at the second application, one or more actions may include informing user (e.g., via a user interface (UI)) that the security tokens are not accepted by the second application and thus need to be updated.

In certain embodiments, at block 226, reasons as to why the system is degraded and/or unhealthy may be provided to a user. These reasons may be provided via UI.

Subsequent to taking one or more actions, at block 228, health checker 152 informs health monitor 154 of the degraded and/or unhealthy status of the system, and in response to receiving this information, health monitor 154 schedules a timer for retry of the health check. In particular, health monitor 154 may schedule subsequent health checks for the system at a predetermined interval or an increasing interval (e.g., to save resources). For example, health monitor 154 may use a timer to specify that subsequent health checks are to be performed every minute until health checker 152 determines that the system is healthy again. These recurrent health checks may be used to monitor the state of the system should it recover independently. These health checks may discontinue when the system is determined to be healthy again.

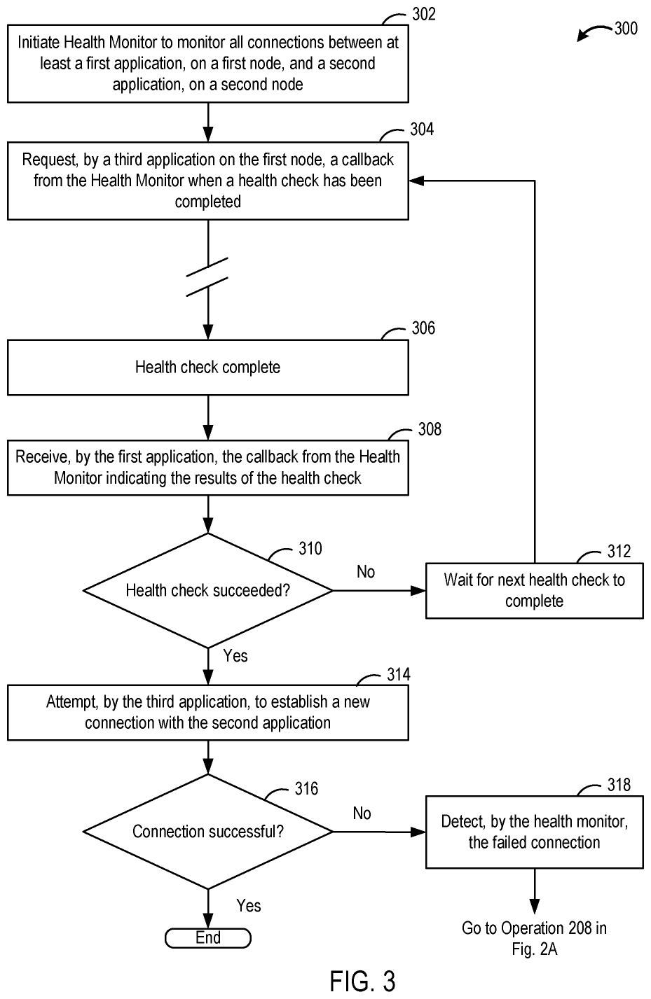

Alternatively, where at block 224 health checker 152 determines that the health check has succeeded (e.g., the system is determined to be healthy), at block 230, health checker 152 informs health monitor 154 of the healthy status of the system. In response to receiving this information from health checker 152, health monitor 154 notifies applications and/or other components in the system that requested a callback from health monitor 154 when the health check completed. Details regarding requesting a callback from health monitor 154 are described with respect to FIG. 3.

At block 250 (e.g., illustrated in FIG. 2C), health monitor 154 determines whether a timer, previously scheduled by health monitor 154, is still running. For example, as illustrated at block 228 in FIG. 2A, when the system is determined to be unhealthy as a result of performing a health check, health monitor 154 may schedule a timer for retry of the health check. Thus, in some cases, a previously scheduled timer may be running.

Where at block 250, health monitor 154 determines that no previously scheduled timer exists (e.g., no timer is running), operations 200 are complete. On the other hand, where at block 250, health monitor 154 determines that previously scheduled timer is still running (e.g., still running when the system is determined to be healthy), at block 252, health monitor 154 attempts to cancel the timer. For example, where the system was previously determined to be unhealthy, a timer may have been set by health monitor 154 such that a health check is performed periodically (e.g., every one minute) until the system is determined to be healthy. If results of the health check are returned prior to a next health check being triggered by the timer (e.g., at the one minute interval) and indicate that the system is healthy, health monitor 154 may attempt to cancel the timer, given an additional health check is no longer necessary.

At block 254, health monitor 154 determines whether the attempt to cancel the timer was successful. Where, at block 254, health monitor 154 is able to successfully cancel the timer, operations 200 are complete. On the other hand, where at block 254, health monitor is not able to successfully cancel the timer, the timer may continue to trigger a subsequent health check for the system. For example, at the completion of the timer at block 256, the timer may cause the initiation of an additional health check for the system. Accordingly, operations 200 may proceed to operation 210 in FIG. 2A to enqueue a health check for the system. Because the system is healthy at this point, results of this additional health check, when performed, may return a result indicating that the system is healthy.

In certain embodiments, other components in the system and/or other applications may request a callback from a health monitor 154 when a health check has completed. In certain embodiments, the callback requesting applications 132 may be applications that are running within a same VM 104 as a health checker 152 and a health monitor 154 initiating and performing the health check. The callback requesting applications 132 may be applications 132 that do not have a failed connection and thus did not cause the initiation of a health check. When a health check is finished, each component and/or application 132 which requested a callback may be informed of the status (e.g., healthy, degraded, or unhealthy) of the system. FIG. 3 illustrates example operations 300 for providing health check results to a callback requesting application, according to one or more embodiments of the present disclosure.

For ease of explanation, operations 300 may be described with respect to an application 132 running in VM 104 on host 102(1) (e.g., a third application) that is requesting a callback for a health check initiated based on a failed connection between an application 132 running in VM 104 on host 102(1) (e.g., a first application) and application 132 running in VM 104 on host 102(2) (e.g., a second application). The third application may be running in the same VM 104 as the first application.

As illustrated, operations 300 begin at block 302, by initiating a health monitor to monitor all connections between at least the first application and the second application. The health monitor may be health monitor 154 running in VM 104 on host 102(1). Initiating health monitor 154 is similar to operations performed at block 204 in FIG. 2A.

At block 304, operations 300 proceed with the third application requesting a callback from health monitor 154 when a health check has completed. The third application may make this request such that the third application is informed about the status (e.g., healthy, degraded, unhealthy) of the system.

As described above with respect to FIGS. 2A-2C, a health check may be initiated and performed in the system either by a timer expiring and/or a one or more failed connections between the first application and the second application. The block 306 in operations 300 a health check performed by health checker 152 on host 102(1) may be complete. Health checker 152 may inform health monitor 154 of the results of performing the health check.

At block 308, in response to receiving the results of the health check, health monitor 154 notifies applications and/or other components in the system that requested a callback from health monitor 154 when the health check completed (e.g., similar to operations at block 230 in FIG. 2A). This includes informing the third application about the results of the health check, as the third application requested a callback from health monitor 154 at block 304.

At block 310, the third application determines whether the health check succeeded (e.g., indicating a healthy status for the system). Where, at block 310, the third application determines that the results indicate that the health check did not succeed (e.g., the health check failed), at block 312, the third application may wait for a next health check to complete. As such, at block 304, the third application may again request a callback from health monitor 154 when a health check has completed. The third application may continue to request callbacks from health monitor 154 until results of a subsequently performed health check are successfully, thereby indicating that the system is healthy.

Alternatively, where, at block 310, the third application determines that the results indicate that the health check did succeed (e.g., the system is healthy), at block 314, the third application may attempt to establish a new connection with the second application. At block 316, the third applications determines whether the attempted connection with the second application was successful. Where, at block 316, the third application determines that the attempted connection was successful, operations 300 may be complete. Alternatively, where, at block 316, the third application determines that the attempted connection was not successful, at block 318, health monitor 154 may detect that the attempted connection has failed. As such, health monitor 154 may be configured to initiate a health check for the failed connection. Thus, subsequent to block 318, operations 300 proceed to operations 200, and more specifically operation 208, in FIG. 2A for initiating and performing a health check.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for connection health monitoring and troubleshooting, comprising:
monitoring a plurality of connections established between a first application running on a first host and a second application running on a second host;
based on the monitoring, detecting two or more connections of the plurality of connections have failed within a first time period;
in response to detecting the two or more connections have failed within the first time period, determining to initiate a single health check between the first host and the second host as opposed to a separate health check between the first host and the second host for each of the two or more connections, wherein initiating the single health check comprises enqueuing a single health check request in a queue to invoke performance of the single health check based on the single health check request;
determining the queue comprises:
a queued active health check request, or
no previously-queued health check requests;
enqueuing the single health check request in the queue; and
performing the single health check based on the single health check request and an order of the single health check request within the queue.

2. The method of claim 1, wherein determining to initiate the single health check for the two or more connections comprises:
determining a separate health check is to be performed for each of the two or more connections that have failed; and
deduplicating the separate health checks to be performed for the two or more connections to the single health check based on the two or more connections failing within the first time period.

3. The method of claim 1, wherein performing the single health check comprises checking whether one or more issues exist at a plurality of layers of the network stack implemented at the first host.

4. The method of claim 1, wherein results of performing the single health check indicate a healthy status, a degraded status, or an unhealthy status.

5. The method of claim 4, wherein when the results of performing the single health check indicate the degraded status or the unhealthy status, the method further comprises:
starting a timer to schedule subsequent health checks, wherein the subsequent health checks are terminated upon results of performing one of the subsequent health checks indicating the healthy status.

6. The method of claim 1, further comprising:
based on the monitoring, detecting two or more other connections of the plurality of connections have failed within a second time period;
in response to detecting the two or more other connections have failed within the second time period, determining to initiate an additional health check for the two or more other connections, wherein initiating the additional health check comprises enqueuing another health check request in the queue to invoke performance of the additional health check based on the other health check request;
determining the queue comprises another queued active health check request and a queued pending health check request; and
deduplicating the other health check request for the two or more other connections with the queued pending health check request.

7. The method of claim 1, further comprising:
receiving, from a third application running on the first host, a first request to receive first results of performing the single health check; and
subsequent to performing the single health check, indicating the first results of performing the single health check to the third application based on receiving the first request.

8. The method of claim 7, wherein when the results of performing the single health check indicate a degraded status or an unhealthy status, the method further comprises receiving, from the third application running on the first host, a second request to receive second results of performing a subsequent health check.

9. A system comprising:
one or more processors; and
at least one memory, the one or more processors and the at least one memory configured to:
monitor a plurality of connections established between a first application running on a first host and a second application running on a second host;
based on the monitoring, detect two or more connections of the plurality of connections have failed within a first time period;
in response to detecting the two or more connections have failed within the first time period, determine to initiate a single health check between the first host and the second host as opposed to a separate health check between the first host and the second host for each of the two or more connections, wherein to initiate the single health check comprises to enqueue a single health check request in a queue to invoke performance of the single health check based on the single health check request;
determine the queue comprises:
a queued active health check request, or
no previously-queued health check requests;
enqueue the single health check request in the queue; and
perform the single health check based on the single health check request and an order of the single health check request within the queue.

10. The system of claim 9, wherein to determine to initiate the single health check for the two or more connections comprises to:
determine a separate health check is to be performed for each of the two or more connections that have failed; and
deduplicate the separate health checks to be performed for the two or more connections to the single health check based on the two or more connections failing within the first time period.

11. The system of claim 9, wherein to perform the single health check comprises to check whether one or more issues exist at a plurality of layers of the network stack implemented at the first host.

12. The system of claim 9, wherein results of performing the single health check indicate a healthy status, a degraded status, or an unhealthy status.

13. The system of claim 12, wherein when the results of performing the single health check indicate the degraded status or the unhealthy status, the one or more processors and the at least one memory are further configured to:
start a timer to schedule subsequent health checks, wherein the subsequent health checks are terminated upon results of performing one of the subsequent health checks indicating the healthy status.

14. The system of claim 9, wherein the one or more processors and the at least one memory are further configured to:
based on the monitoring, detect two or more other connections of the plurality of connections have failed within a second time period;
in response to detecting the two or more other connections have failed within the second time period, determine to initiate an additional health check for the two or more other connections, wherein to initiate the additional health check comprises to enqueue another health check request in the queue to invoke performance of the additional health check based on the other health check request;
determine the queue comprises another queued active health check request and a queued pending health check request; and
deduplicate the other health check request for the two or more other connections with the queued pending health check request.

15. The system of claim 9, wherein the one or more processors and the at least one memory configured to:
receive, from a third application running on the first host, a first request to receive first results of performing the single health check; and
subsequent to performing the single health check, indicate the first results of performing the single health check to the third application based on receiving the first request.

16. The system of claim 15, wherein when the results of performing the single health check indicate a degraded status or an unhealthy status, the one or more processors and the at least one memory are further configured to receive, from the third application running on the first host, a second request to receive second results of performing a subsequent health check.

17. A non-transitory computer-readable medium comprising instructions that, when executed by one or more processors of a computing system, cause the computing system to perform operations for connection health monitoring and troubleshooting, the operations comprising:
monitoring a plurality of connections established between a first application running on a first host and a second application running on a second host;
based on the monitoring, detecting two or more connections of the plurality of connections have failed within a first time period;
in response to detecting the two or more connections have failed within the first time period, determining to initiate a single health check between the first host and the second host as opposed to a separate health check between the first host and the second host for each of the two or more connections, wherein initiating the single health check comprises enqueuing a single health check request in a queue to invoke performance of the single health check based on the single health check request;
determining the queue comprises:
a queued active health check request, or
no previously-queued health check requests;
enqueuing the single health check request in the queue; and
performing the single health check based on the single health check request and an order of the single health check request within the queue.

18. The non-transitory computer-readable medium of claim 17, wherein determining to initiate the single health check for the two or more connections comprises:
determining a separate health check is to be performed for each of the two or more connections that have failed; and
deduplicating the separate health checks to be performed for the two or more connections to the single health check based on the two or more connections failing within the first time period.

19. The non-transitory computer-readable medium of claim 17, wherein performing the single health check comprises checking whether one or more issues exist at a plurality of layers of the network stack implemented at the first host.

20. The non-transitory computer-readable medium of claim 17, wherein results of performing the single health check indicate a healthy status, a degraded status, or an unhealthy status.
